(19) United States
(12) Patent Application Publication
(10) Pub. No.: US 2010/0323106 A1
(43) Pub. Date: Dec. 23, 2010

(54) Apparatus for Automatic Depositing of Multiple Ultra-Thin Layers Using Layer-by Layer Deposition and Method for Using the Same

(76) Inventor: Tarek R. Farhat, Memphis, TN (US)

Correspondence Address: WYATT, TARRANT & COMBS, LLP, 1715 AARON BRENNER DRIVE, SUITE 800, MEMPHIS, TN, 38120-4367, US

(21) Appl. No.: 12/035,933

(22) Filed: Feb. 22, 2008

Related U.S. Application Data
(60) Provisional application No. 60/891,167, filed on Feb. 22, 2007.

(51) Int. Cl. B05D 3/10; B05C 3/02; B05C 11/00

(52) U.S. Cl. 427/214; 118/400; 118/696; 427/352

(57) ABSTRACT

Novel methods and apparatus for thin film layer-by-layer depositions on substrates is provided. More specifically, provided herein is a layer-by-layer deposition of polymers and colloids on substrates of varying sizes and shapes including, for example, flat solid substrates, powder surfaces, flat porous sheets, and micro-porous pipes. Still more specifically, this disclosure relates to an apparatus that can be used to automate the deposition of ultra-thin layers on various substrates of varying sizes and shapes using layer-by-layer deposition and a method for doing the same.

### CROSS-REFERENCE TO RELATED APPLICATIONS

This application claims priority to and the benefit of U.S. Provisional Patent Application No. 60/891,167, filed Feb. 22, 2007.

### FIELD OF THE INVENTION

The present invention relates to thin film layer-by-layer deposition on a substrate. More specifically, the present invention relates to the layer-by-layer deposition of polymers and colloids on substrates of varying sizes and shapes. Still more specifically, the present invention relates to an apparatus that is used to automate the deposition of ultra-thin layers on various substrates of varying sizes using the layer-by-layer deposition and a method for using the same. For example, the present invention is used to deposit thin films on flat solid substrates, powder surfaces, and inside the pores of micro porous pipes or flat porous sheets.

### BACKGROUND OF THE INVENTION

There are many commercial applications where it is beneficial to control the thickness and composition of thin films applied to a substrate. For example, pharmaceutical, electronic, corrosion resistance, textile, and many other fields value thin film technology. Multiple methods exist to apply thin films to substrates including chemical vapor deposition (“CVD”), atomic layer deposition (“ALD”), molecular chemisorption, Langmuir-Blodgett deposition, and layer-by-layer deposition. CVD, ALD, and molecular chemisorption are chemical processes meaning that the deposited materials react with the substrate to form the thin film. The reactants in CVD and ALD are in gaseous form while in molecular chemisorption is either gaseous or liquid.

In Langmuir-Blodgett (“LB”) deposition, amphiphilic molecules are spread on water and compressed until they form a solid-like 2D phase. The LB process assembles thin films based on physical interactions (e.g. electrostatic or dipole-dipole interactions) rather than chemical. Layer-by-layer (“LBL”) process utilizes physical properties and characteristics to attach the deposited material to the substrate, and then to adhere one layer to another creating multiple layers. The physical characteristics utilized are dependent on the nature of the deposited material and the substrate. The materials assemble through short range electrostatic force or long range hydrogen bonding. In both cases the process is thought to be entropy driven. For example, strong polyelectrolytes such as poly(diallyldimethyl ammonium chloride) and poly(styrene sulfonate) form LBL films using electrostatic forces. The pH-controlled deposition of multiple layers of weak polyelectrolytes is used to blend by hydrogen bonding two polyelectrolytes, such as poly(acrylic acid) and poly(allylamine hydrochloride), together to form thin films. There is molecular-level control over composition and surface functionality of the assembled films. If the functional groups along the polyelectrolyte chain are pH dependent, then changing the pH will protonate and deprotonate these groups. Thus, interactions will change from electrostatic to mixed long-range/electrostatic, to pure long range depending on the polyelectrolytes used.

There are automated processes for deposition of thin films using CVD and ALD processes. These systems are very expensive and use specialty gaseous chemicals for thin film or powder deposition. CVD and ALD are not used for aqueous systems and use complex designs, for example, to handle plasma as in ALD. LB deposition is essentially aqueous or liquid and LB instruments use robotic mechanical dippers of different geometries to make single or multilayer films.

The current technology utilizing the LBL technique of applying a thin film involves mounting the substrate on an automated mechanical arm. A computer controlled process lowers the arm holding the substrate into various containers, and holds it in each container for a certain amount of time thereby applying each layer of the thin film. This apparatus is limited to substrates which can be mounted on the mechanical arm. Powders, microspheres, tubules, and porous substrates can not be coated with ultra thin multilayer films using this automated mechanical process.

### BRIEF SUMMARY OF THE INVENTION

The automated flow deposition system of the present invention handles deposition of solutions, emulsions, and colloidal dispersions at room temperature and low pressures (ambient conditions) on substrates of multiple forms. One advantage of the present invention is to assemble thin films on powdered substrates using an automated flow deposition system. Another advantage of the present invention is to deposit thin films using the layer-by-layer method on surfaces inside pores and capillary tubes using an automated flow deposition system. Another advantage of the present invention is to provide an automated flow deposition system with interchangeable modules designed for different substrate materials and shapes. Still another advantage of the present invention is to provide an inert (e.g. under Nitrogen, Helium, Argon or other inert gas), sealed environment for automated flow deposition.

Accordingly, this invention encompasses an automated flow deposition system for depositing thin films on a substrate via layer-by-layer deposition comprising:
a module having a predetermined volume for holding a fluid and means for retaining a substrate disposed within said module such that said substrate will be in contact with said fluid;
at least one chemical receptacle having a predetermined volume for holding a fluid, said chemical receptacle connected to a first opening in said module such that fluid from said chemical receptacle can be transferred to said module, a first valve disposed between said first opening and said chemical receptacle to control fluid transfer;
at least one wash receptacle having a predetermined volume for holding a fluid, said wash receptacle connected to a second opening in said module such that fluid from said wash receptacle can be transferred to said module, a second valve disposed between said second opening and said wash receptacle to control fluid transfer; and
optionally, a waste container having a predetermined volume for holding a fluid, said waste container connected to a third opening in said module such that fluid from said module can be transferred to said waste container, a third valve disposed between said third opening and said waste container to control fluid transfer; and
optionally, an inert gas cylinder connected to a fourth opening in said module such that inert gas from said cylinder can be transferred into said module, a fourth valve disposed between said cylinder and said fourth opening to control fluid transfer, a fifth opening in said module to vent pressure in said module, wherein a valve adjacent to said fifth opening is also present and capable of closing off said fifth opening.

Also encompassed within this invention is a method of using the automated flow deposition system to deposit thin films on a substrate via layer-by-layer deposition comprising:
a) adding a certain volume of a first fluid to a module containing a substrate such that said substrate is in contact with said first fluid;
b) soaking said substrate in said first fluid for a predetermined period of time so that a first thin film layer is adhered to a surface of said substrate,
c) discharging said first fluid from said module;
d) adding a certain volume of a first wash solvent to said module to rinse said substrate such that said substrate is in contact with said first wash solvent;
e) soaking said substrate in said first wash solvent for a predetermined period of time;
f) discharging said first wash solvent from said module;
g) adding a certain volume of a second fluid to a module containing a substrate such that said substrate is in contact with said second fluid;
h) soaking said substrate in said second fluid for a predetermined period of time so that a second thin film layer is adhered to said first thin film layer;
i) discharging said second fluid from said module;
j) adding a certain volume of a second wash solvent to said module to rinse said substrate such that said substrate is in contact with said second wash solvent;
k) soaking said substrate in said second wash solvent for a predetermined period of time; and
l) discharging said second wash solvent from said module.

In such an inventive apparatus and method provided is the ability to coat with thin film layers any type of substrate with any desired film depth. This capability extends to permitting selective deposition on and within certain substrates as well. Previously, only immersion (dipping) was available. To coat, for example, tubes or pipes, it was necessary to immerse the entire target substrate within a fluid and remove any deposited film from the undesired surfaces thereof. With this inventive method and apparatus, such specific internal regions of tube or pipe substrates may be coated without any further steps to remove unwanted films from other areas thereof such a substrate. This invention will be delineated in greater detail with the following drawings, descriptions, and examples.

### BRIEF DESCRIPTION OF THE DRAWINGS

FIG. 1 is a schematic showing the Automated Flow Deposition System.

FIG. 2 is a schematic showing the chemical and wash receptacles.

FIG. 3 is a schematic showing the module of the Automated Flow Deposition System with a trap.

FIG. 4 is a schematic showing an alternative design of a module utilized with the Automated Flow Deposition System.

FIG. 5 is a schematic showing an alternative design of a module utilized with the Automated Flow Deposition System.

FIG. 6 is a schematic showing an alternative design of a module utilized with the Automated Flow Deposition System.

FIG. 7 shows porous and capillary substrates.

### DETAILED DESCRIPTION OF THE DRAWINGS AND PREFERRED EMBODIMENTS

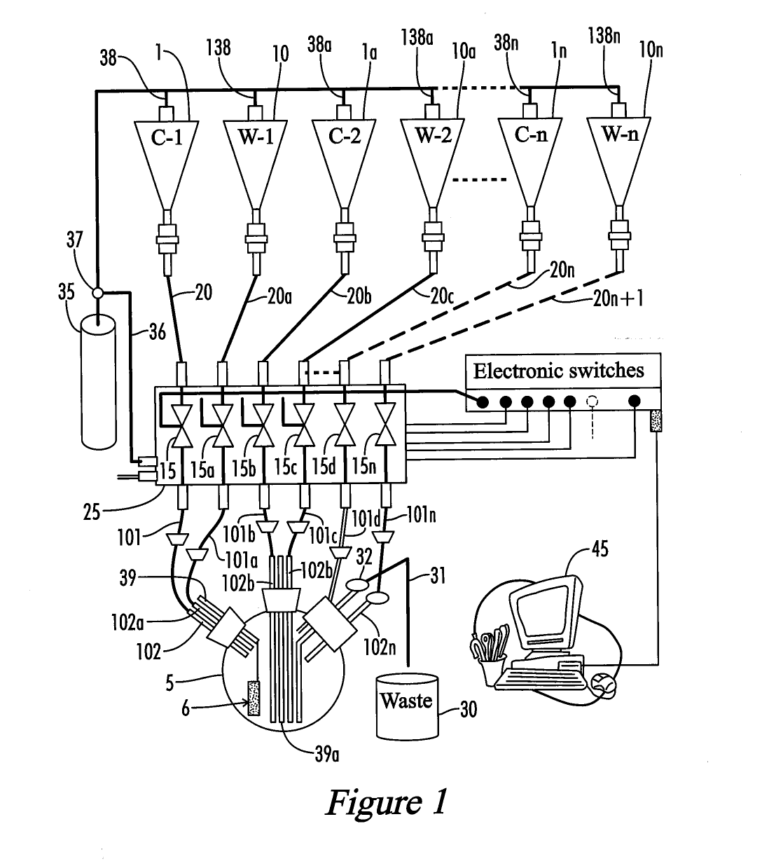

Referring now to FIG. 1, the Automated Flow Deposition System (“AFDS”) comprises at least one chemical receptacle 1 and at least one wash receptacle 10. The AFDS may have as many additional chemical receptacles 1a through 1n and wash receptacles 10a through 10n as necessary for the deposition. The chemical receptacles 1 through 1n contain different solutions suitable for LBL thin film deposition. Some solutions may be polymer solutions, colloidal solutions, and monomer solutions, but those skilled in the art will recognize that other solutions will be suitable for use in the AFDS. The wash receptacles 10 through 10n contain different solvents used in LBL thin film deposition which are selected based on the materials being deposited and the type of substrate. Some of these solvents include water, pH regulated solutions, ionic liquids and organic solvents, but those skilled in the art will recognize that other solvents will be suitable for use in the AFDS. The chemical receptacles 1 through 1n and wash receptacles 10 through 10n are made of any durable material which is selected based on the nature of the solution or solvent housed in the receptacles. Some suggested materials are stainless steel, glass, or plastic.

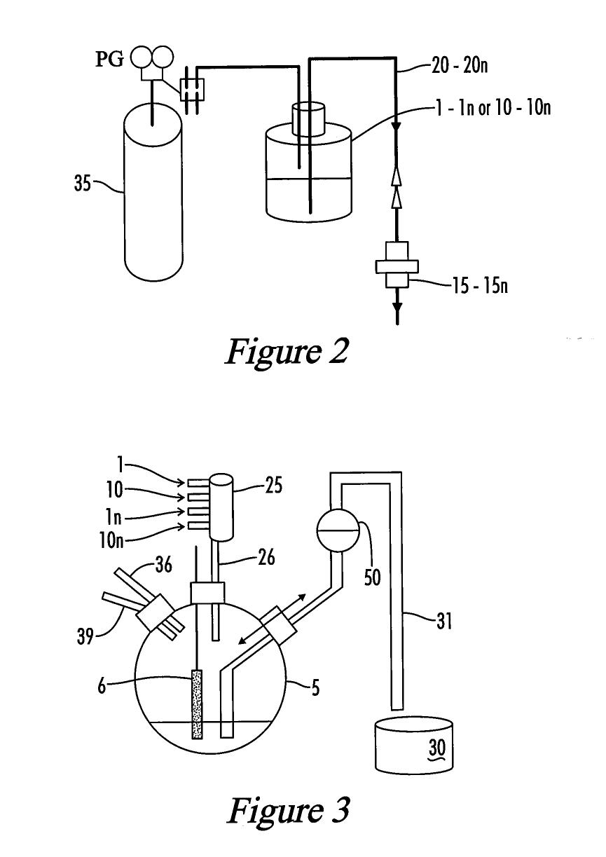

Each chemical receptacle 1 through 1n and wash receptacle 10 through 10n is equipped for thermal treatment of the fluid through coils, temperature baths, hot plates, and the like. Each chemical receptacle 1 through 1n and wash receptacle 10 through 10n is equipped for mechanical agitation of the fluid through sonication, stirring, blending and the like (see FIG. 2). It is noted that the number of deposited chemical materials is not required to be the same in number as that for the wash materials. If desired, the user may have more than one wash receptacle per chemical receptacle (thereby having more than one wash after each chemical deposition to the target substrate). Likewise, if desired, more than one chemical may be deposited prior to washing; such is merely at the discretion of the user. For purposes of merely describing the potentially preferred embodiments, below, a 1:1 ratio of receptacles is illustrated.

Each receptacle 1 through 1n and 10 through 10n is connected to module 5 as described. Hollow tubes 20 through 20x connect chemical receptacle 1 through 1n and wash receptacle 10 through 10n to module 5. Valves 15 through 15x are connected to tubes 20 through 20x and disposed between said receptacles 1 through 1n and 10 through 10n and module 5. In one embodiment, the valves 15 through 15x allow only one way flow. In another embodiment, the valve 15s through 15x allow two way flow. In another embodiment, the valves 15 through 15x are a solenoid valves or the equivalent. In yet another embodiment, the valves 15 through 15x are capable of being electronically controlled.

In one embodiment, the fluid in chemical receptacle 1 through 1n and wash receptacle 10 through 10n flows to the module 5 through tubes 20 through 20x via gravity. In another embodiment, a pump (not shown) transfers the fluid from chemical receptacle 1 through 1n and wash receptacle 10 through 10n to module 5 through tubes 20 through 20x. The pump may or may not be electronically controlled. In another embodiment fluid in chemical receptacle 1 through 1n and wash receptacle 10 through 10n is transferred to module 5 using inert gas pressure. The pressure is supplied to each receptacle 1 through 1n and 10 through 10n by connecting them to a cylinder 35 through pressure tubes 38 through 38n (to chemical receptacles 1 though 1n) and pressure tubes 138 through 138n (to wash receptacles 10 through 10n). Cylinder 35 contains any inert gas such as Nitrogen, Helium, or Argon. Inert gas is delivered to module 5 at a constant pressure using a high pressure regulator and a low pressure gauge. When another fluid is added to module 5, the gas is evacuated through gas vent 39.

In one embodiment, tubes 20 through 20x are attached to manifold 25. This is particularly desirable where the number of chemical receptacles 1 through 1n and/or wash receptacles 10 through 10n is high. Valves 15 through 15x are disposed between manifold 25 and receptacles 1 through 1n and 10 through 10n. Manifold 25 is connected to module 5 by manifold tube 26. In this embodiment, valve 15 through 15x connected to the receptacle 1 through 1n or 10 through 10n containing the desired fluid is opened at any one time allowing flow into module 5 through the manifold 25. All other valves 15x remain closed.

Referring back to FIG. 1, waste container 30 is connected to module 5 by a waste tube 31. A waste valve 32 is attached to tube 31 and disposed between waste container 30 and module 5. The fluid contained in module 5 exits the module 5 through the waste tube 31 and is deposited in the waste container 30. In one embodiment, the fluid drains from module 5 to waste container 30 by gravity. In another embodiment, a pump (not shown) transfers the fluid between module 5 and waste container 30 through waste tube 31. The pump is utilized to empty module 5 into waste container 30. The pump may or may not be electronically controlled.

In yet another embodiment, a cylinder 35 contains inert gas such as Nitrogen, Helium, or Argon. Cylinder 35 is connected to module 5 by gas tube 36. Gas valve 37 is disposed between cylinder 35 and module 5 and is adjoined to gas tube 36. In one embodiment, cylinder 35 is pressurized and inert gas from cylinder 35 flows into module 5 when valve 37 is opened thus forcing the fluid out of module 5 into waste container 30. In a different embodiment, when gas from the cylinder 35 enters the module 5, the fluid is forced back through a two way valve 15 through 15n into the receptacle, thus reserving that fluid for another use. In the embodiment where an inert gas is used to evacuate module 5, it is forced out of module 5 through gas vent 39 as another fluid is added to module 5. The gas vent 39 opens to relieve pressure an closes to build pressure in module 5.

Referring now to FIG. 3, in one embodiment there is a trap 50 disposed between said module 5 and said waste container 30 and connected thereto by waste tube 31. Trap 50 is a container of any shape capable of holding a volume of fluid. Trap 50 allows the added benefit of allowing dynamic bi-directional vertical movement of the fluids in the module 5 unlike other deposition systems. Such bi-directional vertical movement is important in the deposition of polymers and surfactants. Water-soluble polymers deposit faster when the polymer solutions are allowed to flow over the surface rather than remaining static. The trap 50 reduces deposition time and affects the texture of the surface of the films creating a uniform surface.

In this embodiment, fluid in module 5 is transferred to the trap 50 by such as gravity or pressure. It is held in the trap 50 for a specified time and then returned to module 5 via gravity, pressure, or other similar means. This is repeated for multiple cycles. This repeated transfer of fluid between the trap 50 and the module 5 creates a bi-directional vertical movement of the fluid level in module 5 which is beneficial for LBL thin film deposition. Fluid may also pass through the trap 50 into waste container 30 by applying additional pressure or opening waste valve 32.

The module 5 is constructed of any durable material which is selected based on the nature of the fluids housed in the receptacles, for example stainless steel, glass, or plastic. The module 5 is sealed to the surrounding environment to reduce chances of contamination. In one embodiment, module 5 is equipped for thermal treatment of the fluid through coils, temperature baths, hot plates, and the like. In another embodiment, module 5 may be equipped for mechanical agitation of the fluid through sonication, stirring, blending and the like. The substrate 6 is disposed in said module 5 such that it is in contact with the fluid once it is added to module 5. One benefit of the present invention is that module 5 has multiple designs depending on the type of substrate, mechanism of deposition used, and type of experiment. Regardless of the design, the module 5 is interchangeable with the rest of the apparatus. Examples of different modules 5 are included below.

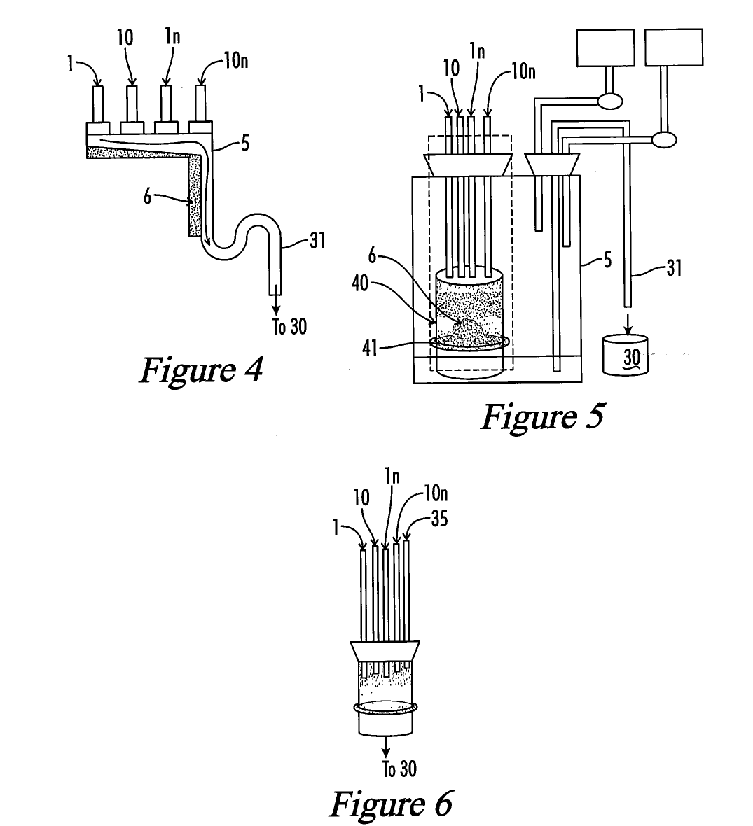

In one embodiment, the substrate 6 is suspended in module 5 such that all sides of the substrate are exposed to the fluid in module 5. One such means of suspending substrate 6 is shown in FIGS. 1 and 3. Referring now to FIG. 4, in another embodiment the substrate is affixed to a side of module 5 such that the fluid flows over a side of substrate 6. Using the arrangement, the LBL deposition occurs under static or continuous flow.

Referring back to FIG. 1, in another embodiment the apparatus is controlled by a computer program 45. For example, the valves, pumps, temperatures, pressures and any other electronically controlled device is activated and deactivated via a computer program 45.

The present invention further comprises an automated method of using the AFDS to deposit multilayer thin films on various substrates using LBL technique. The first layer is deposited by adding a specific volume of a solution from chemical receptacle 1 to module 5. Valve 15 is opened until the correct volume is added to module 5 through a flexible tube 101 connected to a second rigid tube 102. It should be noted that a single tube may be used in place of the first and second tubes 101, 102, not to mention that either tube may be flexible or rigid in nature, rather than one of each type being utilized. The solution is transferred into module 5 through tube 20 by gravity, a pump, pressure, gas displacement or other equivalent means. In one embodiment, the volume may be controlled directly, such as by measuring the volume of the module 5. In another embodiment, the volume may be controlled indirectly such as by measuring the time of addition to the module 5.

The substrate 6 is allowed to soak in the solution for a predetermined amount of time. The time is based on the amount of time needed for a layer of sufficient thickness to be applied to the substrate 6. At the end of the predetermined time, the solution is transferred from module 5 into waste container 30 or back into chemical receptacle 1. In an embodiment where the solution is transferred to the waste container 30, waste valve 32 is opened allowing the transfer through waste tube 31. In another embodiment where valve 15 is a two way valve, valve 15 is opened to allow transfer back into chemical receptacle 1. The solution is transferred into module 5 by gravity, a pump, or other equivalent means.

A specific volume of solvent from wash receptacle 10 is then added to module 5 via a flexible tube 101a and a second rigid tube 102a to wash the substrate 6. The valve 15a is opened until the correct volume of solvent is transferred from wash receptacle 10 through tube 20a to module 5. In one embodiment, the volume may be controlled directly, such as by measuring the volume of the module 5. In another embodiment, the volume may be controlled indirectly such as by measuring the time of addition to the module 5. The substrate 6 is allowed to soak in the solvent for a predetermined amount of time to remove any excess solution. The time is dependent on the materials used to create the layers. At the end of the predetermined time, the solvent is transferred from module 5 into waste container 30 or back into wash receptacle 10. In an embodiment where the fluid is transferred to the waste container 30, waste valve 32 is opened allowing the transfer through waste tube 31. In another embodiment where valve 15a is a two way valve, valve 15a may be opened to allow transfer through tube 20a back into wash receptacle 10. In an alternative embodiment, multiple rinses are required before the next layer is added, in which case the steps in this paragraph are repeated before adding another solution. These transfers may be made by gravity, pump, gas displacement, pressure or other equivalent means.

A second layer is deposited by adding a specific volume of a solution from chemical receptacle 1a to module 5 through tube 20b. Valve 15b is opened until the correct volume is added to module 5 through tube 20b and via flexible tube 101b and rigid tube 102b. The fluid is transferred into module 5 by gravity, a pump, or other equivalent means. In one embodiment, the volume is controlled directly, such as by measuring the volume of the module. In another embodiment, the volume is controlled indirectly such as by measuring the time of addition to the module 5. The substrate 6 is allowed to soak in the solution for a predetermined amount of time. The time is based on the amount of time needed for a second layer of sufficient thickness to be applied to the first layer. At the end of the predetermined time, the solution is transferred from module 5 through waste tube 31 into waste container 30 or back through tube 20b into chemical receptacle 1a. In another embodiment where the fluid is transferred to the waste container 30, waste valve 32 is opened allowing the transfer. In an alternative embodiment where valve 15b is a two way valve, valve 15b is opened to allow transfer back into chemical receptacle 1a. The solution is transferred into module 5 by gravity, a pump, or other equivalent means.

A specific volume of solvent from wash receptacle 10a is then added to module 5 to wash the substrate 6. The valve 15c is opened until the correct volume of solvent is transferred from wash receptacle 10a through tube 20c to module 5 and via flexible tube 101c and rigid tube 102c. In one embodiment, the volume may be controlled directly, such as by measuring the volume of the module. In another embodiment, the volume may be controlled indirectly such as by measuring the time of addition to the module 5. The substrate 6 is allowed to soak in the solvent for a predetermined amount of time. The time is dependent on the materials used to create the layers. At the end of the predetermined time, the solvent is transferred from module 5 into waste container 30 or back into wash receptacle 10. In one embodiment where the fluid is transferred to the waste container 30, waste valve 32 is opened allowing the transfer through waste tube 31. In another embodiment where valve 15c is a two way valve, valve 15c is opened to allow transfer back into wash receptacle 10a through tube 20c. In an alternative embodiment, multiple rinses are required before the next layer is added, in which case the steps in this paragraph are repeated before adding another solution. These transfers are made by gravity, pump, gas displacement, or other equivalent means.

The solution addition step is repeated n number of times, where n is the number of total chemical receptacles 1 through 1n. Similarly the solvent addition step is repeated n number of times, where n is the number of total wash receptacles 10 through 10n, through tubes 20n and 20 n+1, valves 15d through 15n, flexible tubes 101d through 101n, and rigid tubes 102d through 102n. In another embodiment, instead of soaking in the fluids for a set amount of time, a certain volume of fluid flows over the substrate 6. One benefit of this embodiment is that only small amounts of fluid are used so there is little waste. In an alternative embodiment, all of these steps are controlled by computer program 45. For example, the valves, pumps, temperatures, pressures and any other electronically controlled devices are activated and deactivated via the computer program. In another embodiment, when the computer program is activated, a menu is displayed on the monitor that allows the user to input the required parameters. There are three types of inputs, the NUMBER input, the TIME input, and the PROBE input. The NUMBER input specifies variables such as the number of bilayers to be deposited and the number of washings or rinses with solvent. The TIME input specifies variables such as the time needed to get the required volume of liquid and the time needed to soak the substrate in liquid. The PROBE input is used to activate processes such as electrochemical treatment, stirring and heating. In yet another embodiment, where the substrate needs electrochemical treatment during deposition, the PROBE input activates a potentiostat to run during the time of deposition to modify the substrate. In another embodiment, where the solution inside the module needs stirring or heating, the PROBE input activates a stirrer or a heater to agitate the solution.

### i. Alternative Embodiments of Module and Methods of Operating the Apparatus

Module 5 is designed differently based on the substrate form. One benefit of the present invention is that module 5 has multiple designs depending on the type of substrate, mechanism of deposition used, and type of experiment. Module 5 easily disconnects from the AFDS. There are multiple designs of modules for the AFDS which are interchangeable. To simplify, the drawings showing these modules are confined to two chemicals and two washings, but those who are skilled in the art will recognize that these designs are applicable for a plurality of chemicals and a plurality of washings. Each module is designed based on the following parameters: (1) type of substrate used. (e.g. Flat solid, Flat porous, tubular, cylindrical, powder, etc.); (2) mechanism of deposition applied (e.g. one-way or two-way flow, soaking, agitation, etc.); (3) type of experiment used (e.g. Electrochemical, thermal, sonication, stirring, etc.).

One advantage of all designs of module 5 is that it uses one sealed container rather than many open containers. Another advantage is that the environment can be controlled so that the substrate is exposed to inert gases between deposition and wash cycles versus atmospheric air. Another advantage of module 5 is that it allows the substrate to connect to instrumentation for surface modification such as electrochemical and electrical power supplies.

In all the experiments discussed below, the deposition of soluble polymers (e.g. polyelectrolytes) or powders is done by functionalizing the substrate surface with the appropriate reagent. For example, most metallic surfaces, whether flat or powder substrates, possess an intrinsic positive charge and thus can be functionalized with negatively charged polyelectrolytes such as PSS, PAA, etc. Metals can also be functionalized with thiols such as thiopropane sulfonate to render their surface strongly negative for the next polycation deposition. Cellulosic filter papers are negatively charged, thus we functionalize them with polycations such as PDAC, PAH, etc. before the next polycation powder coating deposition. Surfaces such as silicon wafers and glass slides are negatively charged and are functionalized with polycations such as PDAC, PAH, etc. before the next polyanion deposition.

Treatment of the surface with the appropriate reagent allows a strong physical interaction between the functionalized surface and the next added layer. The physical interaction is either electrostatic or long range hydrogen bonding. These same interactions cause the other layers to adhere to each other to form a thin film or to cement particles together in case of thin powder films assembly.

### ii. Module Configuration for Flat Solid Substrates

Referring now to FIG. 1, using this set up module 5 is suitable for flat solid substrates. Flat solid substrates include any flat solid surface, smooth or rough. Flat solid substrates must first be pretreated for LBL deposition. Pretreatment is done by cleaning with strong acids and peroxide solutions (any strength), ammonia and peroxide solutions, chromic acid baths, strong bases, any suitable detergent, plasma etching or any equivalent. Those who are skilled in the art will recognize that such pretreatment is standard for LBL deposition and any standard pretreatment will suffice. Substrates can be made of the following materials: glass slides, glass sheets, silicon or any kind of semiconductor wafers, plastic sheets, metallic sheets, and any solid sheet a LBL can deposit on. Also included are flat perforated sheets (bore>0.5 mm) of any of the above materials. Those skilled in the art will recognize that there are many other equivalent substrates that can also be used with this apparatus.

Referring now to FIG. 1, the module 5 for flat substrate coating comprises a container of any shape (spherical, cylindrical, conical or other shape) that accommodates certain volume of fluid and one or more substrates for LBL thin film deposition. The flat substrate is suspended or mounted inside module 5 in such a way that it is held firmly and is not discharged through the waste tube 31. One advantage of this module 5 is that the substrate can be rotated or spun during the deposition or wash processes. It is connected to the rest of the apparatus as described above.

Another advantage of this module 5 is that electrochemical experiments can be run during a particular deposition or rinse stage. For example, a potentiostat instrument can be used to apply electrochemical activation on the substrate before rinsing with water and depositing chemicals from chemical receptacle 1 through 1n.

### Film Deposition Examples

### i. Flat Solid Substrates

The Flat Solid Substrate set up module 5 is particularly suited to LBL depositions which do not form colloids, but sediment. A Sediment is a mixture of solution and powder where the powder does not remain suspended but settles down to the bottom of the container. For example, with a mechanical dipper the substrate is mounted on a robotic arm while the mixture is placed in a deposition beaker. Dipping the substrate in the mixture where the powder already settled fails to deposit any powdered film. On the other hand, with automated flow, more particles are retained in solution and then stabilized by polymer solutions from successive depositions. In this embodiment, powder is added to at least one of the fluids in chemical receptacles 1 through 1n. The powder may be added by mixing or stirring or other similar means.

### Example 1

In the deposition process PAA is placed in the chemical receptacle 1 while PDAC is placed in 1a. The substrate 6 is soaked in the first polymer solution (PAA) for 7 minutes and washed three times with pure water for 2 minutes. This is repeated for the second polymer solution PDAC. The powdered films were stabilized with six bilayers. The results were: (a) Aluminum powder (5 micron) stabilized with six bilayers of poly(diallyldimethyl ammonium chloride) [PDAC; MW=240,000]; and Poly(2-acrylamido-2-methyl-1-propane sulfonic acid) (PAMPS). The film tended to form a porous structure due to phase separation; (b) Silver powder (5 micron) stabilized with six bilayers of poly(diallyldimethyl ammonium chloride) [PDAC; MW=240,000]; and poly(acrylic acid) [PAA; MW=90,000]. The silver film was electrically conductive where the resistance between 1 cm point contacts was 0.5 to 1.0 ohm; (c) Zinc powder (5 micron) stabilized with six bilayers of poly(diallyldimethyl ammonium chloride) [PDAC; MW=240,000]; and poly(acrylic acid) [PAA; MW=90,000] was non conductive because the zinc particles were covered by an oxide layer; (d) graphite powder (10 to 15 micron) stabilized with six bilayers of poly(diallyldimethyl ammonium chloride) [PDAC; MW=240,000]; and poly(acrylic acid) [PAA; MW=90,000] was conductive. If more bilayers are applied the graphite is more stable but its conductance decreases; (e) carbon black powder (0.1 to 0.5 micron) stabilized with six bilayers of poly(diallyldimethyl ammonium chloride) [PDAC; MW=240,000]; and poly(acrylic acid) [PAA; MW=90,000] was highly conductive and all samples prepared were stable. At this stage, the thickness of these powder films was in the submillimeter (200 to 400 microns) range rather than the submicron range because the mass of the Sediments deposited was around 0.03 gcm-2. We have purposefully prepared these thick films because the surface roughness of the substrates used (i.e. filter papers) was at least 100 microns. Most powdered films prepared were stable to mild scratching and did not flake off even when using a scotch tape. However, the 15 micron graphite films were not that stable and some samples used to flake off.

### ii. Powder Substrates

Referring now to FIGS. 5 and 6, using the filter set up module 5 is suitable for substrates that are powders (e.g. 10 mesh to 325 mesh), microspheres (e.g. 10 microns), and flat porous sheets that can not be coated by simple soaking or dipping. Powder coating means to coat each particulate with a thin polymer film. In the filter set up module 5, the powder is agitated and trapped by the retaining filter. The size of the powder particles dictates using retaining filter with pores less than the minimum size particles of the powder. That is, if the powder particulates range from 5 to 10 microns then the pores of the retaining filter do not exceed 4 microns. A substrate holder 40 is attached to the module 5. A filter 41 may be placed in the substrate holder 40 such that the fluid from receptacles 1 through 1n and 10 through 10n flows through the filter 41. The pore size of the filter 41 is smaller than the size of the powder particles so that the powder remains on the filter 41 and the fluid passes through. After the deposition step is complete, the fluid is transferred out of the module 5 through waste tube 31.

### Example 2

Metallic powders, such as copper, were coated with poly(diallyldimethyl ammonium chloride) [PDAC; MW=240,000]; and poly(acrylic acid) [PAA; MW=90,000] and organic powder diodobenzene was coated with PDAC and PAA to make hollow microcapsules using the AFDS with the filter type set up. In the deposition process PAA is placed in the chemical receptacle 1 while PDAC in 1a. The substrate is soaked in each of the polymer solutions for 10 minutes and washed three times with pure water 2 minutes after each polymer solution soak. A maximum of 20 bilayers and a minimum of 5 bilayers were applied as a coating on these powders. Conventional mechanical dippers are incapable of coating sample powders due to the nature of the dipping process.

### iii. Porous and Capillary Coating

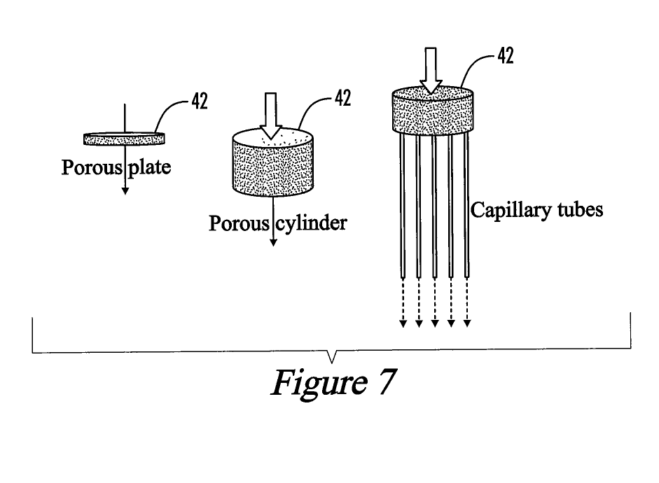

If module 5 is pressurized, it is suitable for substrates that are tubular with internal diameter less than 500 microns as well as micro-porous pipes (e.g. 10 microns pores) for example porous substrates and capillary tubes as shown in FIG. 7. Under normal conditions, liquids can not pass all the way into the pores of porous substrates or all the way through capillary tubes due to hydrophobic capillary force. In this embodiment, module 5 uses pressure to force liquid into tiny pores and cavities allowing thin films to be formed by LBL deposition in those pores and cavities.

The module 5 is pressurized under the pressurized set up. The pressure is monitored using a pressure gauge. Under the pressurized set up, module 5 is made of a material that can withstand high pressure such as stainless steel or similar materials. The pressure is maintained at a level that forces the liquid through the pores or tubes of the porous substrates 42 such that the entire interior surface of the pore or tube is coated. The pressure required is dependent on the size of the pore or tube to be coated. The porous substrate 42 (FIG. 7) is placed in the substrate holder 40 (FIG. 6) such that the fluid from receptacles 1 through 1n and 10 through 10n flows into the pores of the porous substrate 42. After the deposition step is complete, the fluid is transferred out of the module 5 through waste tube 31.

### Example 3

The process was tested on a porous stainless steel plate (SS316) of pore size 5 to 7 microns. The porous (SS316) plate was pretreated with dilute ammonia solution. In the deposition process PAA is placed in the chemical receptacle 1 while PDAC in 1a. The substrate is soaked in each polymer solution for 4 minutes and washed three times with pure water 2 minutes after each polymer solution soak. A maximum of 20 bilayers were deposited.

While the invention will be described and disclosed in connection with certain preferred embodiments and practices, it is in no way intended to limit the invention to those specific embodiments, rather it is intended to cover equivalent structures structural equivalents and all alternative embodiments and modifications as may be defined by the scope of the appended claims and equivalence thereto.

What is claimed is:

1. An automated flow deposition system for depositing thin films on a substrate via layer-by-layer deposition comprising:
a module having a predetermined volume for holding a fluid and means for retaining a substrate disposed within said module such that said substrate will be in contact with said fluid;
at least one chemical receptacle having a predetermined volume for holding a fluid, said chemical receptacle connected to a first opening in said module such that fluid from said chemical receptacle can be transferred to said module, a first valve disposed between said first opening and said chemical receptacle to control fluid transfer;
at least one wash receptacle having a predetermined volume for holding a fluid, said wash receptacle connected to a second opening in said module such that fluid from said wash receptacle can be transferred to said module, a second valve disposed between said second opening and said wash receptacle to control fluid transfer; and
optionally, a waste container having a predetermined volume for holding a fluid, said waste container connected to a third opening in said module such that fluid from said module can be transferred to said waste container, a third valve disposed between said third opening and said waste container to control fluid transfer; and
optionally, an inert gas cylinder connected to a fourth opening in said module such that inert gas from said cylinder can be transferred into said module, a fourth valve disposed between said cylinder and said fourth opening to control fluid transfer, a fifth opening in said module to vent pressure in said module, wherein a valve adjacent to said fifth opening is also present and capable of closing off said fifth opening.

2. The system of claim 1 wherein said waste container and said inert gas cylinder are both present.

3. The system of claim 1 wherein said system is controlled via computer means.

4. A method of using the automated flow deposition system to deposit thin films on a substrate via layer-by-layer deposition comprising:
a) adding a certain volume of a first fluid to a module containing a substrate such that said substrate is in contact with said first fluid;
b) soaking said substrate in said first fluid for a predetermined period of time so that a first thin film layer is adhered to a surface of said substrate,
c) discharging said first fluid from said module;
d) adding a certain volume of a first wash solvent to said module to rinse said substrate such that said substrate is in contact with said first wash solvent;
e) soaking said substrate in said first wash solvent for a predetermined period of time;
f) discharging said first wash solvent from said module;
g) adding a certain volume of a second fluid to a module containing a substrate such that said substrate is in contact with said second fluid;
h) soaking said substrate in said second fluid for a predetermined period of time so that a second thin film layer is adhered to said first thin film layer;
i) discharging said second fluid from said module;
j) adding a certain volume of a second wash solvent to said module to rinse said substrate such that said substrate is in contact with said second wash solvent;
k) soaking said substrate in said second wash solvent for a predetermined period of time; and
l) discharging said second wash solvent from said module.

5. The method of claim 4 where:
said addition, soaking, and discharge of said wash solvent is repeated a plurality of times between each single said addition, soaking, and discharge of said fluid.

6. The method of claim 4 wherein said substrate is a flat substrate.

7. The method of claim 4 wherein said substrate is a powder substrate.

8. The method of claim 4 wherein said substrate is a tube substrate.

9. The method of claim 5 wherein said substrate is a flat substrate.

10. The method of claim 5 wherein said substrate is a powder substrate.

11. The method of claim 5 wherein said substrate is a tube substrate.
